(19) United States
(12) Patent Application Publication
(10) Pub. No.: US 2016/0103061 A1
(43) Pub. Date: Apr. 14, 2016

(54) Reaction Vessel, Reaction Vessel Arrangement and Method for Analyzing a Substance

(71) Applicant: Analytik Jena AG, Jena (DE)

(72) Inventor: Jörg Weber, Jena (DE)

(21) Appl. No.: 14/852,258

(22) Filed: Sep. 11, 2015

(30) Foreign Application Priority Data
Sep. 12, 2014 (DE) 10-2014-113-163.0
Sep. 12, 2014 (DE) 20-2014-104-316.0

(51) Int. Cl. G01N 21/03; G01N 21/25

(52) U.S. Cl. CPC G01N 21/0303; G01N 21/255; G01N 2021/0389; G01N 2201/068

(57) ABSTRACT

The invention concerns a reaction vessel (1) for analyzing a substance, comprising a storage chamber (2) with a circular cross section and at least one measuring chamber (3), wherein the storage chamber (2) and the measuring chamber (3) are interconnected in a transition area (UB) and are intended to receive the substance, wherein the measuring chamber (3) has several pairs of two opposing, plane-parallel measuring windows composed of a transparent material successively configured in the axial direction of the reaction vessel (1) and/or transversely to this axial direction (F1, F2; F3, F4; F5, F6; F7, F8) and wherein a distance (A1, A2, A3) between the measuring windows of a pair (F1, F2; F3, F4; F5, F6) is different from a distance (A2, A3, A1) between the measuring windows of the remaining pairs (F3, F4; F5, F6; F1, F2).

The invention further concerns a reaction vessel arrangement (11) for analyzing a substance, comprising several interconnected reaction vessels (1) and a process for analyzing a substance inside a reaction vessel (1), wherein the substance is processed and optically examined inside said reaction vessel (1).

The invention concerns a reaction vessel for analyzing a substance.

The invention further concerns a reaction vessel arrangement for analyzing a substance, comprising several interconnected reaction vessels.

The invention further concerns a process for analyzing a substance located inside a reaction vessel.

Examination methods in analysis, particularly bioanalysis, in which optical measurement of reagent solutions, sample solutions, or mixtures thereof in reagent vessels in order to verify intermediate results or record a final result are generally known from the prior art. By means of these optical measurements, effects such as absorption and fluorescence effects are recorded and evaluated. For carrying out these examination methods, reagent solutions, sample solutions or mixtures thereof in the reaction vessels are manipulated. Depending on the mode of application, there are different types of reaction vessels, which in general, particularly in bioanalysis, are designed for a single use per examination procedure. Processing of a large number of test samples is ordinarily carried out automatically, wherein the reaction vessels are correspondingly configured for this purpose. Temporary storage of the intermediate or final results or solutions thereof is also frequently carried out, wherein the reaction vessels are also correspondingly configured.

Most optical measurements in liquids are carried out in cuvettes referred to as standard cuvettes, or cuvettes with special shapes and optical layer thicknesses for the liquids to be examined. Here, standard cuvettes are mostly characterized by a layer thickness of 10 mm and show two pairs each of side walls arranged plane-parallel to each other. Layer thickness is understood in this case to refer to a distance between inner sides of each pair of the side walls arranged plane-parallel to each other.

Such a cuvette for optical analysis of small volumes is described in WO 2008/2008128534 A1. The cuvette is composed of a structured carrier substrate and a channel, wherein the carrier substrate is planar and configured to be optically transparent and the channel has two measuring chambers with differing channel depths. One side of the carrier substrate is sealed with a thin, optically transparent film having two fluid interfaces that are connected to the channel in a fluid-conducting manner. The other side of the carrier substrate is also sealed with a thin, optically transparent film.

Moreover, DE 198 26 470 A1 discloses a cuvette for measuring absorption of radiation in liquid samples that is composed of transparent plastic in the area of the windows. The cuvette comprises an internal space that is configured with a box-shaped upper part having an upper opening for filling and removal of sample liquid and a smaller box-shaped lower part for the measurement volume connected via a transition component. The cuvette further comprises two pairs of opposing, plane-parallel windows in the lower part, wherein the distance between the windows of the one pair is different from the distance between the windows of the other pair in order to provide different layer thicknesses of the sample liquid for measurement. Moreover, four feet aligned in the corners of the upper parts are provided which extend from the upper part to the level of a bottom of the lower part.

U.S. Pat. No. 4,263,256 describes cuvettes for use in a device for automatic testing of liquid samples. Here, the cuvettes are arranged in a continuous integral strip, wherein the strip between adjacent cuvettes is elastically configured so that relative angular movement of adjacent cuvettes in a horizontal and vertical plane is possible. The cuvettes show a square cross section.

A further arrangement of several cuvettes in such a strip is described in U.S. Pat. No. 5,048,957. In this case, the cuvettes have a circular cross section.

DE 196 52 784 A1 discloses a cuvette for receiving, transport and storage of liquids and for conducting optical measurements in an analysis device. The cuvette is made of a transparent plastic for irradiation and measurement of light and has a shape that ensures the storage of liquid during the reaction. Its underside has a device for receiving the required volumes of liquid, and its upper side is configured with a conical connector for receiving an exchangeable tip device.

DE 695 19 783 T2 describes a process for following the formation of a nucleic acid amplification reaction product in real time. In this case, in a first process step, a closed reaction chamber that contains a mixture is prepared. The reaction mixture comprises a nucleic acid molecule and a first fluorescence indicator for each nucleic acid molecule, wherein the first fluorescence indicator emits a first fluorescent signal when it is irradiated with excited electromagnetic radiation. An intensity of the first signal is proportional to the amount of amplification product in the volume of the reaction mixture that is irradiated with the excited electromagnetic radiation. The first signal is spectrally resolvable, wherein the closed reaction chamber comprises a wall component for optical transmission and a cavity between the wall component and a surface of the reaction mixture. Furthermore, in a second process step, amplification of the nucleic acid molecules is carried out. In a repeating third process step, a beam of excited electromagnetic radiation is directed into the reaction mixture and the intensity of the first signal is detected, wherein the beam and the detected signal are transmitted via the wall component. The reaction mixture also comprises a second fluorescence indicator that is homogeneously distributed throughout the entire reaction mixture and emits a second fluorescent signal when it is irradiated with excited electromagnetic radiation. An intensity of the second signal is proportional to the volume of the reaction mixture that is irradiated with the beam of excited electromagnetic radiation, wherein the second signal is spectrally resolvable with respect to the first signal and the beam is focused in the reaction mixture. In a third process step, the intensity of the second signal and the ratio of the intensity of the first signal to that of the second signal is calculated, wherein the ratio is proportionate to the amount of the amplified product.

Furthermore, DE 32 46 592 C2 discloses a cuvette for mixing and for optical inspections of liquids with a low receiving volume and a high filling level carried out in the area of a measuring zone with opposing parallel, narrow wall sections, at least for introducing radiation, and between configured side walls. In a cross section, perpendicular to the central axis of the cuvette, a transition element is configured in a curved shape between the parallel, narrow wall sections and the side walls. In the measuring zone, the side walls show an arched curvature. This curvature is drawn inward with respect to the arched transition elements to such a degree that in the cross section, an average tangent of the wall sections intersects with them at the edge of their respective plan-parallel areas or intersects so far in that even with double-cone measuring light, the curvature tangentially approaches convergence of the measuring light.

DE 11 2010 002 641 T5 describes a cuvette for measuring absorption or scattering resulting from irradiation of liquid detectors, wherein the cuvette comprises a conical upper body with an internal space to receive a sample fluid detector, wherein an internal space is formed in the upper body and the upper body has an opening for filling and removal of sample fluid. Furthermore, the cuvette comprises a smaller box-shaped lower body for a measurement volume that is connected to the upper body via a transition element. Two pairs of opposing plane-parallel windows are configured in the lower body, wherein a distance between the windows of one pair is different from a distance between the windows of another pair.

The purpose of the invention is to provide an improved reaction vessel for analyzing a substance, an improved reaction vessel arrangement for analyzing a substance, and an improved process for analyzing a substance located inside a reaction vessel compared to the prior art.

The purpose of the invention is achieved for the reaction vessel by the characteristics given in claim 1, for the reaction vessel arrangement by the characteristics given in claim 11, and for the process by the characteristics given in claim 14.

Advantageous embodiments of the invention are the subject matter of the subclaims.

The reaction vessel according to the invention for analyzing a substance comprises a storage chamber with a circular cross section and at least one measuring chamber, wherein the storage chamber and the measuring chamber are interconnected in a transition area and are intended to receive the substance, wherein the measuring chamber has several pairs of two opposing, plane-parallel measuring windows each composed of a transparent material successively configured in plane-parallel levels in the axial direction of the reaction vessel and/or transversely to this axial direction, wherein a distance between the measuring windows of a pair is different from a distance between the measuring windows of the remaining pairs.

Analysis is understood in this case to refer to all process steps for processing the substance, for example thorough mixing, centrifuging processes, addition of further substances and optical, chemical and mechanical processes for examining the substance.

Here, the measuring chamber is understood to be a space in which a defined volume of the substance can be taken up. The measuring chamber can be closed with a bottom element on a side facing away from the transition area. Alternatively, the measuring chamber is configured such that it is not closed on this side, wherein the substance flows through the measuring chamber for the purpose of analysis, or for example is maintained inside the measuring chamber by means of a vacuum generated by a liquid column of the substance.

The reaction vessel according to the invention makes it possible, in a particularly advantageous manner, to economically carry out analysis of the substance to be analyzed, particularly a liquid or a gas, as both processing, i.e. manipulation of the substance, and an optical measurement procedure, for which at least two plane-parallel measuring windows are absolutely required to obtain reliable measurement results, can be carried out in one and the same vessel. In this case, the optical measuring process can be carried out effectively in the course of the detection method with no or at least minimal additional effort. No laborious refilling of the substance to be analyzed is required between the individual analysis steps and the optical measuring processes.

In contrast, reaction vessels known from the prior art solely having a circular cross section are characterized by being usable for processing the substance to be analyzed, but not for precise optical examination thereof, as the circular shape means that no two vessel walls stand parallel opposite each other at a site in the reaction vessel that is larger than infinitesimally small. A configuration of a measuring window with a layer thickness defined in one dimension with a lateral extension that is larger than infinitesimally small does not exist in such reaction vessels of the prior art, so that the requirement for precise optical measurement of the contents of the vessels through their vessel walls is not met.

In contrast, the measuring chambers configured according to the invention, which in particular are characterized by a circular shape of the vessel walls with a changing radius in a transition area of the storage chamber, form an area of the reaction vessel that is limited but larger than infinitesimally small, in which the opposing vessel walls are parallel to one another and form the measuring windows. These opposing parallel measuring windows allow precise optical measurement of the substance to be analyzed.

Because of the connection between the storage chamber and measuring chamber in the transition area, the contents of the reaction vessel are located both in the storage chamber and at the same time in the measuring chamber. The reaction vessel can therefore be filled with substances such as liquids or gases, and filling of the measuring chamber will occur simultaneously. The same applies on emptying of the reaction vessel.

Furthermore, layer thicknesses deviating from 10 mm, which are determined by the distance between plane-parallel measuring windows, can be realized. Because of the configuration of the reaction vessel according to the invention, simple handling thereof in an automated analysis process of the substance to be analyzed is possible, wherein the reaction vessel allows manual or automatic processing, storage and optical examination of the substance under optimum conditions.

Compared to the prior art, moreover, in which it is assumed that a solely circular cross section and a solely square cross section of the reaction vessel adversely affect thorough mixing of the substance to be analyzed, the configuration according to the invention surprisingly provides particularly favorable thorough mixing because of the different cross sections of the storage and measuring chambers and the measuring windows configured therein.

This circular cross section, compared to a square cross section, allows simple handling, arrangement, alignment, and positioning in a device for automated analysis, simpler weldability to a covering element, and reduced material requirements and cost in the production of the reaction vessel while retaining equal or greater capacity for the substance to be analyzed and the same or greater mechanical stability.

The configuration of the measuring chamber with several pairs of two opposing and plane-parallel measuring windows each makes it possible in a particularly advantageous manner to carry out different optical measuring processes simultaneously or successively. Because a distance between the measuring windows of a pair is different from a distance between the measuring windows of the remaining pairs, the measuring chamber of the one reaction vessel allows different layer thicknesses to be realized, which in turn makes it possible to carry out different optical measuring processes by means of one and the same reaction vessel. In this case, in a particularly beneficial manner, the successive arrangement of the pairs of measuring windows in the axial direction of the reaction vessel and/or transversely to this axial direction and the resulting parallel course of the optical axes of the measuring windows of different pairs means that only a relatively linear movement of the measuring chamber of an analysis unit in an axial direction or transversely to this is required. In this case, movement of the reaction vessel and/or the analysis unit is possible. In contrast to non-linear movements, particularly circular movements, this linear movement can be carried out with significantly reduced expense and extremely high accuracy. In particular, as no realignment of the reaction vessel with respect to its size is required after the relative movement, in addition to maintaining precision, significantly less time is required.

In a particularly advantageous embodiment, it is also possible using a reaction vessel in which the measuring windows are arranged in particular only in four mutually plane-parallel levels to simultaneously detect different layer thicknesses in a single measurement procedure through several measuring window pairs at the same time by means of a correspondingly configured analysis unit and to analyze the substance in the different layer thicknesses.

Here, the reaction vessel is configured for example as a cuvette. A configuration referred to as a throughflow cuvette is also possible. In this case, an analysis of the substance during throughflow inside the measuring chamber is possible. Alternatively, the throughflow can also at least temporarily be stopped so that analysis of the substance is also possible when there is no substance flowing inside the measuring chamber.

In an alternative embodiment, the reaction vessel is configured as a pipette, wherein the measuring chamber is open on the side facing away from the transition area. In analyzing the substance, the vessel is kept inside the measuring chamber, in particular by means of the vacuum generated by the liquid column of the substance. Thus, the substance can be directly analyzed in a particularly advantageous manner in various layer thicknesses without refilling the pipette.

In an improvement, the storage chamber has a circular opening on an upper end that is bordered on its edge by a casing surface of the storage chamber, wherein a projection completely surrounding the casing surface on the end side and outer side and running essentially perpendicularly to the casing surface is configured in the area of the opening. In this case, the opening configured on the upper side makes it possible to carry out simple manual or automated filling in a particularly advantageous manner. The surrounding projection serves in this case on the one hand to stabilize the storage chamber, and on the other hand, in a particularly advantageous manner, serves to securely lock and position the reaction vessel in a carrier device, for example in a device for automated analysis of the substance.

In order to allow simple and certain insertion of the reaction vessel into a corresponding opening of such a carrier device, the radius of the circular cross-section of the storage chamber according to a possible improvement decreases from an upper end to a lower end of the storage chamber.

In a further possible embodiment, wall areas of the measuring chamber between the measuring windows of a pair show a curved cross section. In particular, this reduces the radius of the storage chamber in the transition area and maintains a cross section in the areas in which the measuring windows are not configured that corresponds to a circular section or is configured in a parabolic shape. The curved shape of the cross section also makes it possible, in a particularly advantageous manner, to simply insert the reaction vessel into the corresponding opening in the carrier device.

According to a possible embodiment, at least one projecting element running essentially perpendicularly to a circular upper opening of the storage chamber can be configured on an outer side of the storage chamber in order to also allow a defined angular orientation of the reaction vessel in the corresponding opening of the carrier device and thus an optimum orientation of the reaction vessel in the optical examination, which element can be arranged in particular in a corresponding notch in a wall bordering the opening of the carrier device.

In a possible embodiment, in order to achieve further improved positioning and locking of the reaction vessel in the carrier device, at least one projection-shaped locking element arranged essentially perpendicularly to a bottom element configured on the lower end is formed, which in turn can be brought into mechanical contact with a corresponding structure configured on the carrier device so that the reaction vessel is also securely maintained in the lower area.

A further aspect to be considered is the available volume of the substance for measurement. In many applications there is only a small volume of substance available. The necessary measurement volume is therefore to be reduced as far as possible in filling a measuring chamber. Measurements with small, but also with larger volume should be possible in the same manner, without having to specially separate off a small volume because of a limited measuring chamber. For this reason, according to a further embodiment, a volume of the storage chamber is at least 10 times greater than a volume of the measuring chamber. This also ensures simple handling of the substance in the reaction vessel even with a very small volume for optical measurement.

In a possible embodiment, the entire reaction vessel is made from one piece of highly transparent material, for example a plastic or glass. The plastic can for example be a technical polymer, particularly from the group referred to as the cycloolefin copolymers, also abbreviated as “COC”.

In an improvement of the reaction vessel, only parts of the reaction vessel are made of the transparent material. For example, only the measuring chamber or only the measuring windows of the measuring chamber are made of the transparent material. Other than the measuring chamber or the measuring windows, the reaction vessel, for example, is made of a material that is unfavorable for optical measurement but advantageous for use of the reaction vessel. In a possible embodiment, the reaction vessel is made of a mechanically flexible material at the upper opening of the storage chamber, so that it is possible to simply and reliably achieve fluid-tight closure of the opening by means of a cover or a fluid-tight connection with other objects. For example, the mechanically flexible material can be polypropylene or a thermoplastic polymer. Production of the reaction vessel can therefore be carried out, for example, by means of an injection molding process in which the entire reaction vessel is molded from the various materials. In this case, it is possible that the injection process of the various sections of the reaction vessel can take place with the various materials in a common injection mold, or finished components can be placed in the injection mold and then sprayed with other materials to produce a fluid-tight connection among the sections.

In a possible improvement, the reaction vessel can be made of either plastics or non-plastics. Properties of each section of the reaction vessel can therefore easily be adapted to functions of the sections.

The reaction vessel arrangement according to the invention for analyzing a substance comprises several interconnected reaction vessels according to the invention or possible embodiments or improvements thereof. The reaction vessel arrangement formed in this manner combines all of the above-described advantages of the reaction vessel and is therefore particularly outstanding in advantageous handling, in use in automated analysis processes, and in storage of the substance, combined with the property of feasibility of manual or automatic optical measurements under optimum conditions. Here, the reaction vessel arrangement according to the invention can be operated by most automatic devices, but also by manual equipment in the laboratory and is suitable for optical analysis of the substance, for example by means of photoluminescence or chemiluminescence methods. The reaction vessels of the reaction vessel arrangement are also suitable for widespread use as optical measuring cuvettes, above all for absorption measurements, as these are characterized by a fixed, precisely defined layer thickness. In this case there is a favorable relationship between the filling volume and measurement volume of the substance.

In a possible improvement, the reaction vessels are configured next to one another in a linear or curved arrangement such that normal orientations of the circular openings configured on the upper end of the storage chambers run parallel to one another respectively. In this manner, simple filling thereof with the substance to be analyzed and simple handling and arrangement of the reaction vessel arrangement in the device provided for analysis can be realized.

According to a possible improvement, in order to allow simple and at the same time efficiently practicable closure of the individual reaction vessels, a covering element for closing an opening of the reaction vessel is arranged on each reaction vessel by means of a mechanically flexible connecting element, or a composite structure of several covering elements is arranged on one or more of the reaction vessels by means of a mechanically flexible connecting element, wherein a distance between the covering elements in the composite structure corresponds to a distance from the reaction vessel in the area of the opening to be closed.

In the process according to the invention, in analysis of a substance located inside a reaction vessel according to the invention or possible embodiments or improvements of said substance, the substance inside said reaction vessel is processed and optically examined. Therefore, no time-consuming refilling of the substance to be analyzed between the individual analysis steps and the optical measuring processes is required, which results not only in preventing the loss of the substance when residual amounts remain in a reaction vessel, but at the same time significantly reduces the time required to analyze the substance. This process can be carried out with great precision and particularly low expenditure, particularly because of the successive arrangement of the measuring window pairs in the axial direction of the reaction vessel pairs, as only relative linear movement of the measuring chamber of an analysis unit in an axial direction is required.

Examples of the invention are explained in further detail below with reference to drawings.

The figures are as follows:

FIG. 1 schematically shows a first side view of a first example of a reaction vessel according to the invention,

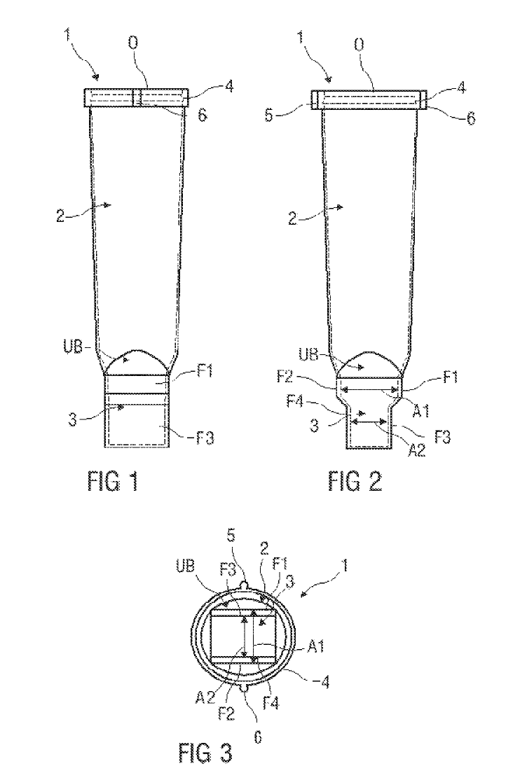

FIG. 2 schematically shows a second side view of the reaction vessel according to FIG. 1,

FIG. 3 schematically shows a top view of a bottom element of the reaction vessel according to FIG. 1,

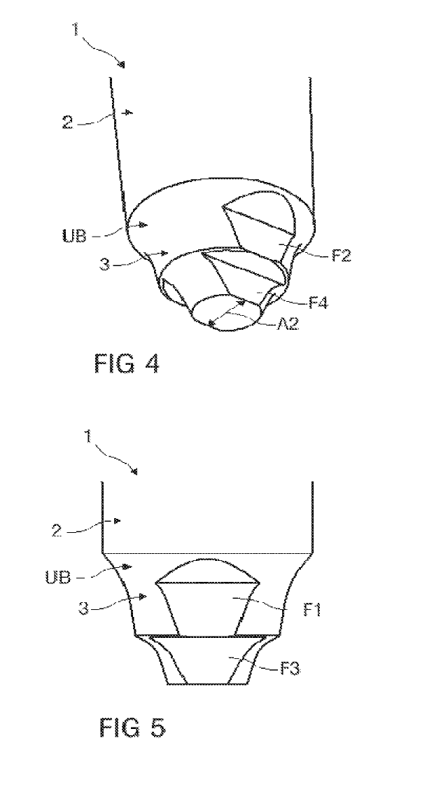

FIG. 4 schematically shows a perspective view of a section of a second example of a reaction vessel according to the invention,

FIG. 5 schematically shows a first side view of the reaction vessel according to FIG. 4,

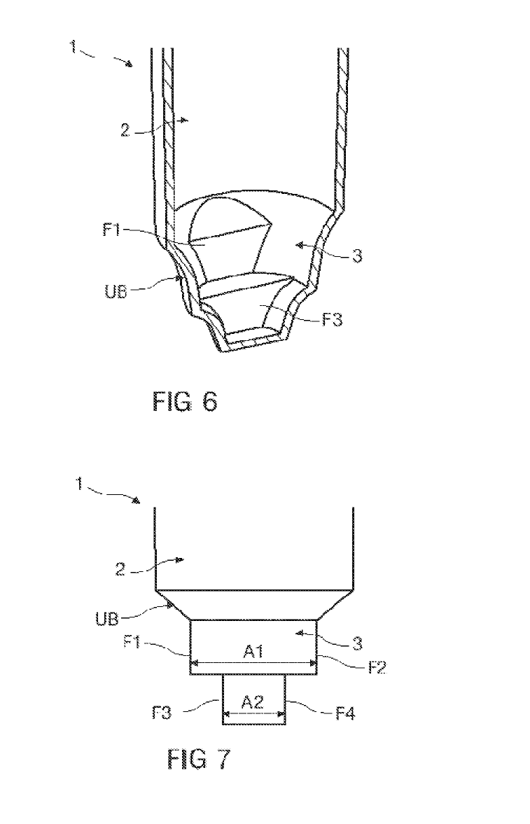

FIG. 6 schematically shows a perspective view of a sectional representation of the reaction vessel according to FIG. 4,

FIG. 7 schematically shows a second side view of the reaction vessel according to FIG. 4,

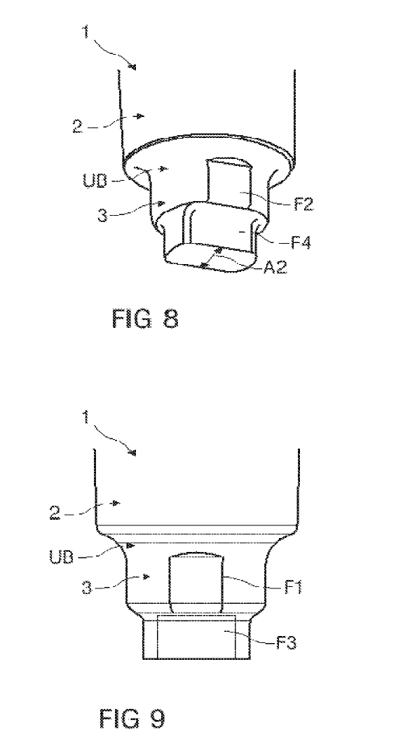

FIG. 8 schematically shows a perspective view of a section of a third example of a reaction vessel according to the invention,

FIG. 9 schematically shows a first side view of the reaction vessel according to FIG. 8,

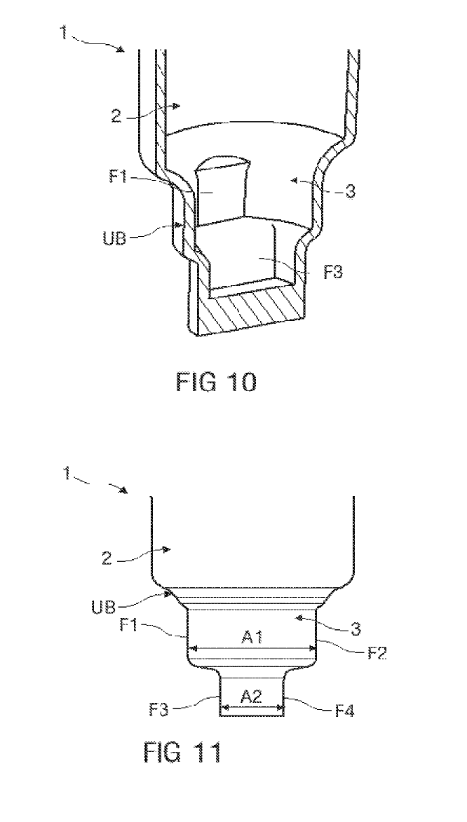

FIG. 10 schematically shows a perspective view of a sectional representation of the reaction vessel according to FIG. 8,

FIG. 11 schematically shows a second side view of the reaction vessel according to FIG. 8,

FIG. 12 schematically shows a perspective view of a section of a fourth example of a reaction vessel according to the invention,

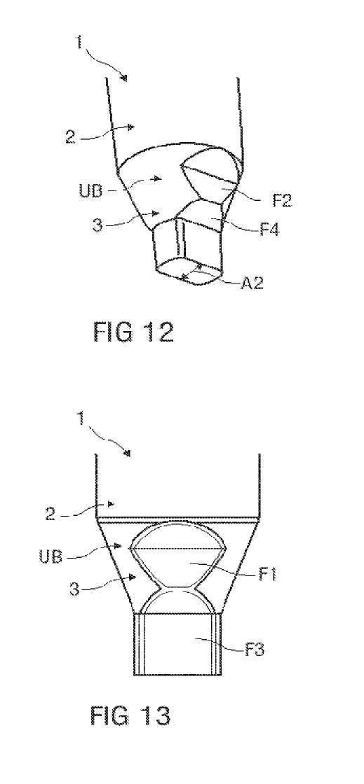

FIG. 13 schematically shows a first side view of the reaction vessel according to FIG. 12,

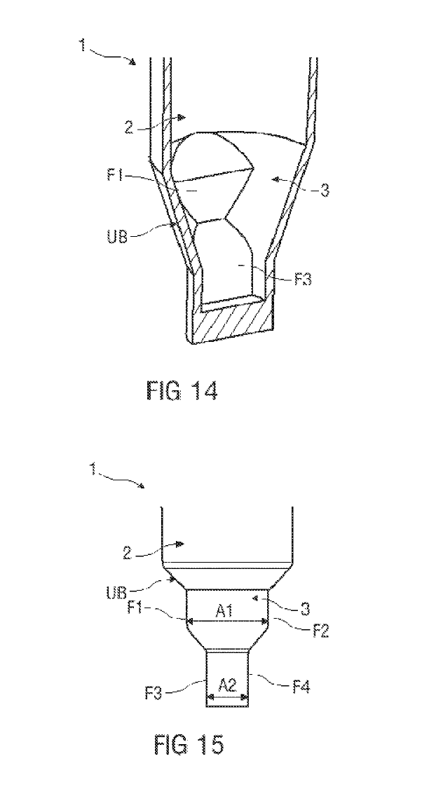

FIG. 14 schematically shows a perspective view of a sectional representation of the reaction vessel according to FIG. 12,

FIG. 15 schematically shows a second side view of the reaction vessel according to FIG. 12,

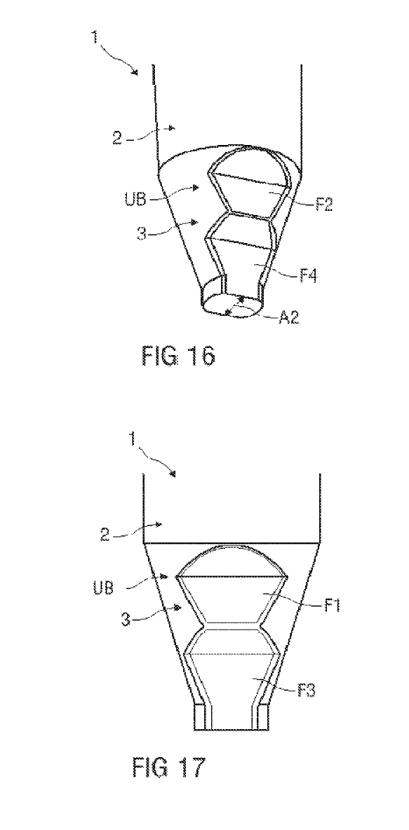

FIG. 16 schematically shows a perspective view of a section of a fifth example of a reaction vessel according to the invention,

FIG. 17 schematically shows a first side view of the reaction vessel according to FIG. 16,

FIG. 18 schematically shows a perspective view of a sectional representation of the reaction vessel according to FIG. 16,

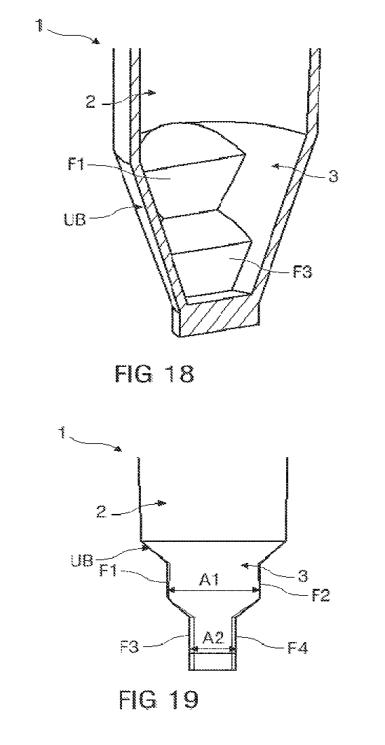

FIG. 19 schematically shows a second side view of the reaction vessel according to FIG. 16,

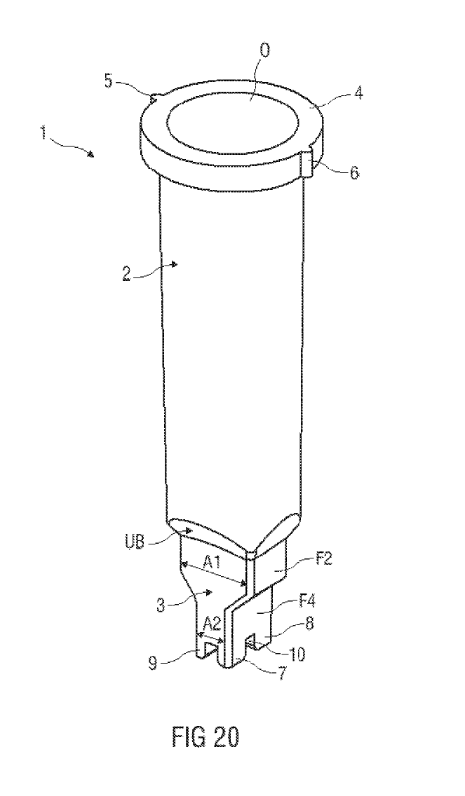

FIG. 20 schematically shows a perspective view of a sixth example of a reaction vessel according to the invention,

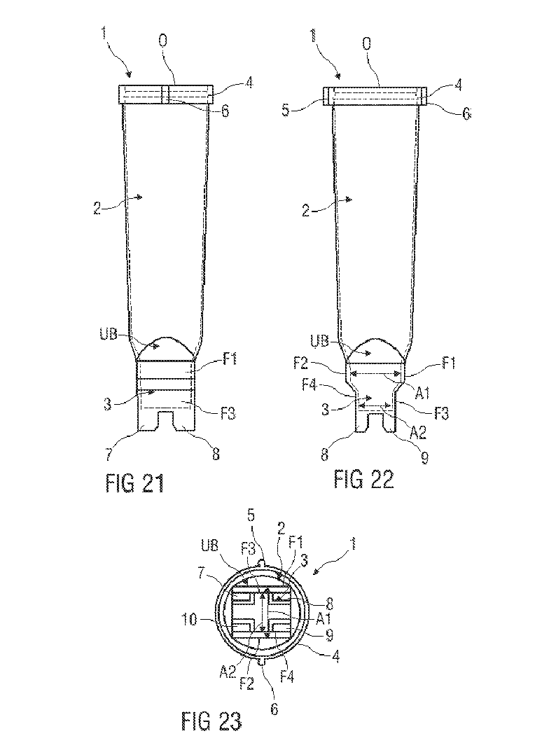

FIG. 21 schematically shows a first side view of the reaction vessel according to FIG. 20,

FIG. 22 schematically shows a second side view of the reaction vessel according to FIG. 20,

FIG. 23 schematically shows a top view of a bottom element of the reaction vessel according to FIG. 20,

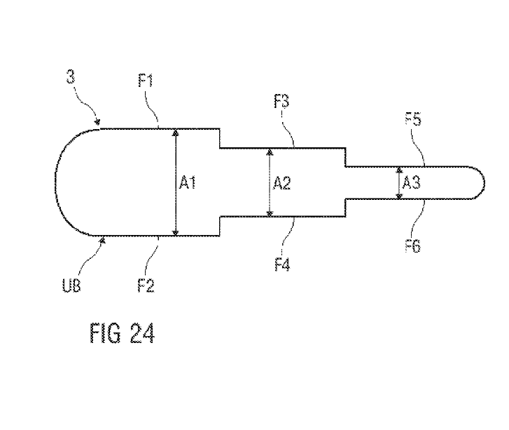

FIG. 24 schematically shows a perspective view of a seventh example of a reaction vessel according to the invention,

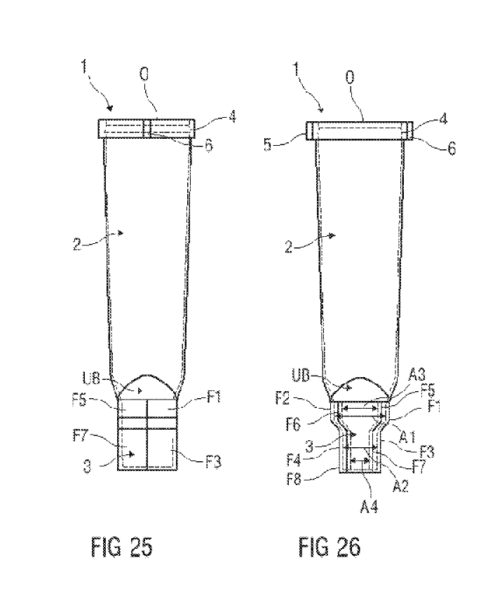

FIG. 25 schematically shows a first side view of an eighth example of a reaction vessel according to the invention,

FIG. 26 schematically shows a second side view of the reaction vessel according to FIG. 25,

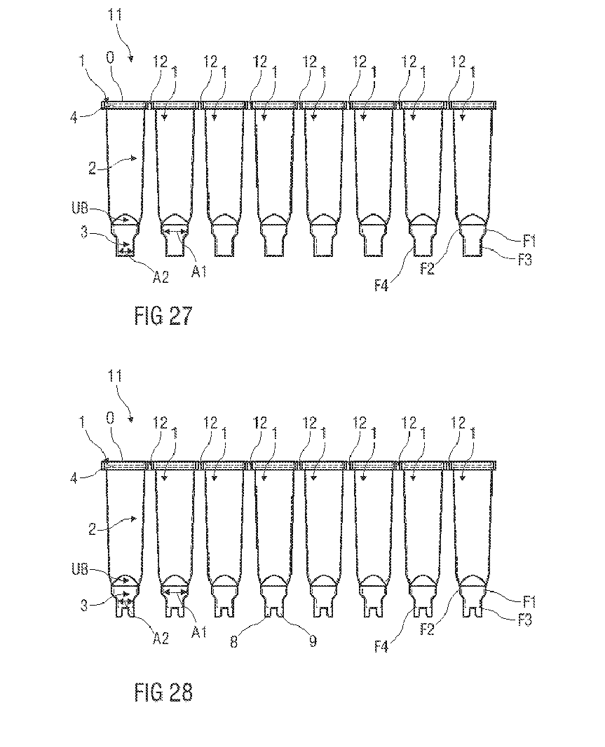

FIG. 27 schematically shows a side view of a first example of a reaction vessel arrangement according to the invention,

FIG. 28 schematically shows a side view of a second example of a reaction vessel arrangement according to the invention,

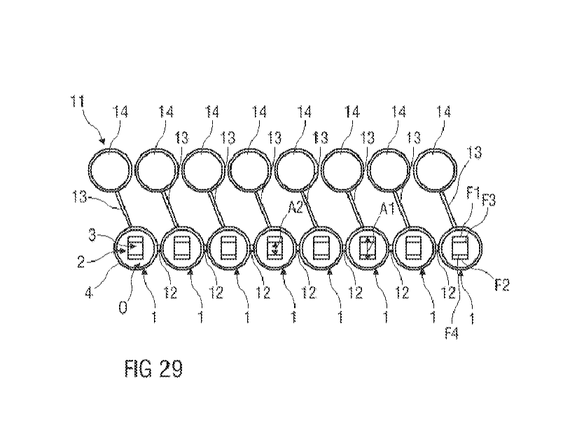

FIG. 29 schematically shows a top view of a second example of a reaction vessel arrangement according to the invention,

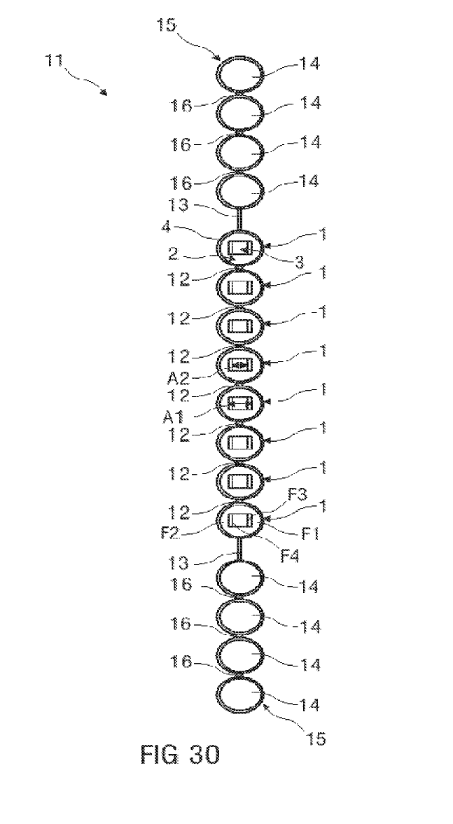

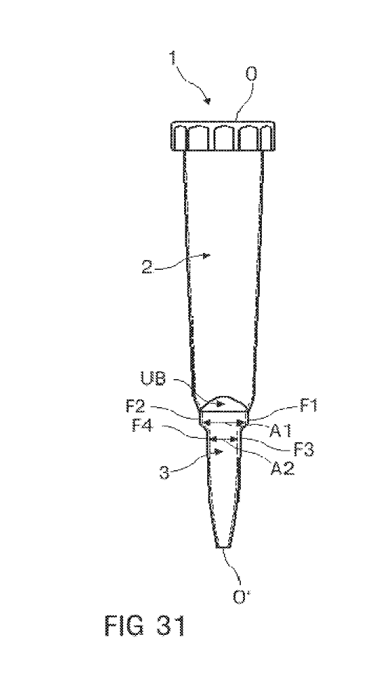

FIG. 30 schematically shows a top view of a third example of a reaction vessel arrangement according to the invention, and

FIG. 31 schematically shows a side view of a ninth example of a reaction vessel according to the invention configured as a pipette tip.

Parts corresponding to one another are shown in all of the figures with the same reference numbers.

FIGS. 1 through 3 show various views of a possible first example of a reaction vessel 1 according to the invention for the analysis of a substance not shown, particularly a liquid or a gas. Such analyses are carried out for example in testing of nucleic acids, i.e. what are referred to as DNA tests, wherein the nucleic acid is first extracted from the substance for this purpose and is then optically measured by means of an optical measuring process, for example a spectroscopic process.

The reaction vessel 1 is configured as a cuvette in the example shown and comprises a storage chamber 2 and a measuring chamber 3, wherein the storage chamber 2 and the measuring chamber 3 are interconnected in a transition area UB and are intended to receive the substance. The reaction vessel 1 is composed of a transparent material, particularly a transparent plastic, and is produced for example by an injection molding process. The plastic can for example be a technical polymer, particularly from the group referred to as the cycloolefin copolymers, also abbreviated as “COC”.

In examples not shown in further detail, it is provided that only parts of the reaction vessel 1 are made of the transparent material. For example, solely the measuring chamber 3 or the measuring windows F1 through F4 of the measuring chamber 3 are made of the transparent material. Other than the measuring chamber 3 or the measuring windows F1 through F4, the reaction vessel 1, for example, is made of a material that is unfavorable for optical measurement but advantageous for use of the reaction vessel 1. In a possible embodiment, the reaction vessel 1 is made of a mechanically flexible material at the upper opening O of the storage chamber 2, so that it is possible to close the opening O by means of a cover 14 shown in FIGS. 29 and 30 in a fluid-tight and simple manner. For example, the mechanically flexible material can be polypropylene or a thermoplastic polymer.

The storage chamber 2 having a circular cross section has a circular opening O on an upper end that is bordered on its edge by a casing surface of the storage chamber 2. A projection 4 completely surrounding the casing surface on the end side and outer side and running essentially perpendicularly to the casing surface is configured in the area of the opening O that serves in particular to lock and position the reaction vessel 1 in a device for automatic and/or manual analysis of the substance that is not shown.

Furthermore, there are two opposing projecting elements 5, 6 that run essentially perpendicularly to the circular upper opening O on an outer side of the storage chamber 2 and are intended for locking of the reaction vessel 1 in a notch corresponding thereto that is not shown in an opening in the wall bordering the device.

In order to allow simple positioning of the reaction vessel 1 in such a device, the radius of the circular cross section of the storage chamber 2 decreases from its upper end to a lower end of the storage chamber 2.

In the transition area UB, the radius is further reduced, and the cross section gradually changes from circular to square in such a way that the measuring chamber 3 has successively configured pairs of two opposing and plane-parallel measuring windows F1, F2; F3, F4 each in the axial direction of the reaction vessel 1, wherein the measuring windows F1, F2; F3, F4 are arranged solely in four mutually plane-parallel levels. In this case a distance A1 between the measuring windows of a pair F1, F2; F3, F4 is different from a distance A2 between the measuring windows F1, F2; F3, F4 of the remaining pair, wherein the distance A1 of two opposing casing surfaces in a transition area gradually decreases to the distance A2. For example, distances A1 and A2 differ by 1 mm. Different layer thicknesses can therefore be achieved in analyzing the substance.

Optical investigations of the substance, particularly measurements of the substance in spectroscopic processes, are therefore possible in the area of the measuring chamber 3. For this purpose, the plastic of the reaction vessel 1 shows particularly high transparency in the visible, infrared, and ultraviolet wavelength regions, particularly 200 nm to 300 nm. Optical measurement of the substance with light in the ultraviolet wavelength region is conducted in particular in purity measurements.

By means of these optical measurements, absorption and fluorescence effects of the respective substance, among others, are recorded and evaluated. Because of the perpendicular arrangement of the measuring windows of different pairs F1, F2; F3, F4, it is possible, in a particularly advantageous manner, to detect the light produced by fluorescence with a measuring window F1, F2; F3, F4 configured at a 90° angle to the irradiated light, thus minimizing the effect of the irradiated light and the resulting glare in measurement.

Here, a volume of the storage chamber 2 is at least 10 times greater than a volume of the measuring chamber 3. For example, the storage chamber 2 has a volume of more than 100 μL, for example 200 μL to 2000 μL. It is thus possible for the measuring chamber to be filled to capacity after only small volumes are added to the reaction vessel 1, and optical measurement of the substance can always be achieved under the same conditions regardless of the total filling level in reaction vessel 1.

In a particularly advantageous manner, the reaction vessel 1 makes it possible to carry out the process according to the invention, wherein while analyzing the substance located inside the reaction vessel 1, this substance can be processed and optically examined inside said reaction vessel 1. This means, in the example of examination of nucleic acids, that the nucleic acid is first extracted from a corresponding substance located in the reaction vessel 1 and is then optically measured in the same reaction vessel by means of the spectroscopic process.

FIGS. 4 through 7 show various views of a second example of the reaction vessel 1 according to the invention, wherein in contrast to the first example shown in FIGS. 1 through 3, the radius in the transition area UB decreases further, and the cross section essentially retains its circular shape. Only in the area of the two successively configured pairs of two opposing and plane-parallel measuring windows F1, F2; F3, F4 each in the axial direction of the reaction vessel 1 is the cross section configured in a flattened shape, so that the measuring windows F1, F2; F3, F4 are arranged plane-parallel to one another. Wall areas of the measuring chambers 3 between the measuring windows of a pair F1, F2; F3, F4 therefore show a circular cross section.

FIGS. 8 through 19 show various views of third, fourth and fifth examples of the reaction vessel 1 according to the invention, which differ from the first example by having deviating courses of the wall areas of the reaction vessel 1 transition area UB.

FIGS. 20 through 23 show various views of a possible sixth example of the reaction vessel 1 according to the invention. In contrast to the first embodiment shown in FIGS. 1 through 3, four projection-shaped locking elements 7 through 10 arranged essentially perpendicularly to a bottom element formed on the lower end are configured on an outer side of a lower end of the reaction vessel, said elements serving for fixation, adjustment, and locking of the reaction vessel 1 in the device for conducting the analysis.

The locking elements 7 through 10 enclose a cross-shaped structure, which has been found to be particularly advantageous in locking.

The locking elements 7 through 10 can also be arranged on all other possible reaction vessels 1 either falling under or not falling under the subject matter of the invention in the area of a bottom element for locking of the respective reaction vessel 1 in a device.

For all of the examples of the reaction vessel 1 shown, the measuring chamber 3, in contrast to the bottom area shown, can alternatively be configured in the casing area of the reaction vessel 1. Several measuring chambers 3 can also be configured on the bottom area and/or in the casing area in a manner not further shown.

FIG. 24 shows a possible seventh example of the reaction vessel 1 according to the invention. The example shown is intended to clearly show that the number of pairs of measuring windows F1, F2, F3, F4, F5, F6 is as desired, but there must be more than one pair. In the example shown, the measuring chamber comprises three pairs of measuring windows F1, F2, F3, F4, F5, F6, wherein different distances A1 through A3 are configured between the respective measuring windows F1, F2; F3, F4; F5, F6 of the pairs.

FIGS. 25 and 26 show in a side view a possible eighth example of the reaction vessel 1, which differs from the first example shown in FIGS. 1 through 3 in that in addition to the two pairs of in each case two opposing and plane-parallel measuring windows F1, F2; F3, F4 successively arranged in the axial direction of the reaction vessel 1, two further pairs of measuring windows F1, F2; F3, F4; F5, F6; F7, F8 are successively arranged in the axial direction of the reaction vessel 1, transversely to the axial direction next to the measuring windows F1, F2; F3, F4. Here, a distance A3 between the measuring windows of a pair F5, F6 is different from a distance A4 between the measuring windows F7, F8 of the remaining pair, wherein the distance A3 of two opposing casing surfaces gradually decreases in a transition area to the distance A4.

In this case, any desired arrangement and number of pairs of measuring windows F1, F2; F3, F4; F5, F6; F7, F8 is possible, with the proviso that the pairs are configured successively, and only in four mutually plane-parallel levels arranged in mutually plane-parallel fashion, in the axial direction of the reaction vessel 1 and transversely to this axial direction.

In a deviation from the example shown, it is also possible in such an arrangement of the measuring windows F1, F2; F3, F4; F5, F6; F7, F8 to provide additional locking elements 7 through 10, and in the transition area UB, a course of the transition elements between the measuring windows F1, F2; F3, F4; F5, F6; F7, F8 and the wall areas of measuring chamber 3 between the measuring windows of a pair F1, F2; F3, F4; F5, F6; F7, F8 can be configured in accordance with the examples shown in FIGS. 4 through 24.

FIG. 27 shows a possible first example of a reaction vessel arrangement 11 according to the invention, wherein the reaction vessel arrangement 11 is characterized by comprising reaction vessels 1 interconnected by means of mechanically flexible projection-shaped elements 12 according to the first example shown in FIGS. 1 through 3. In improvements not shown in further detail, other embodiments of the reaction vessels 1 can be connected to such a reaction vessel arrangement 11, for example those shown in FIGS. 4 through 25.

In the example shown, eight of the reaction vessels 1 are configured next to one another in a linear or curved arrangement such that the normal orientations of the circular openings O configured on the upper end of the storage chambers 2 run parallel to one another respectively. This means that the measuring chambers 3 of the individual reaction vessels 1 are also arranged parallel to one another. However, the number of reaction vessels 1 lined up next to one another can also be selected as desired. Because of this linear arrangement of the measuring chamber 3 and of the measuring windows F1 through F4 of the reaction vessels arranged next to one another 1, only linear movement of an analysis unit along the measuring chambers 3 is required, wherein a measurement procedure of optical analysis can be carried out simultaneously in a particularly advantageous manner on the substance in several layer thicknesses because of the arrangement of the measuring windows F1 through F4.

This number of eight reaction vessels 1 combined into a reaction vessel arrangement 11 is often used in practice, particularly in automated systems in what is referred to as “liquid handling”, but also in manual analysis processes. The number of twelve reaction vessels 1 combined into a reaction vessel arrangement 11 is also often used, so this number is also preferred.

In the reaction vessel 1, a distance from the center of a respective opening O to the center O of an opening of an adjacent reaction vessel 1 is e.g. 9 mm.

In particular, the mechanically flexible and projection-shaped elements 12 are configured such that individual or several reaction vessels 1 can be separated from the remaining reaction vessel arrangement 11. For this purpose, in a manner not shown in further detail, predetermined breaking points can be provided in the projection-shaped elements 12 or between them and the respective reaction vessels 1.

FIG. 28 shows a possible second example of a reaction vessel arrangement according to the invention 11, wherein the second example differs from the first example shown in FIG. 15 in that it comprises several reaction vessels 1 interconnected by means of mechanically flexible projection-shaped elements 12 according to the sixth example shown in FIGS. 20 through 23.

FIG. 29 shows a top view of a possible third example of the reaction vessel according to the invention arrangement 11. In contrast to the first example shown in FIG. 15, a covering element 14 for closing the opening O of the reaction vessel 1 is arranged on each reaction vessel 1 by means of a mechanically flexible, particularly strap-shaped, connecting element 13. Each reaction vessel 1 of the reaction vessel arrangement 11 can therefore be closed separately by means of a covering element 14. Because of the circular design of the storage chamber 2 and thus the opening O and the covering element 14, this closure can be carried out particularly simply and reliably.

FIG. 30 shows a top view of a possible fourth example of the reaction vessel arrangement 11 according to the invention. In contrast to the first example shown in FIG. 16, a composite structure 15 of four covering elements 14 each is arranged on each of the two outer reaction vessels 1 of the reaction vessel arrangement, connected to the respective reaction vessel 1 by means of a mechanically flexible, particularly strap-shaped connecting element 13. Here, projection-shaped elements 16 arranged between the individual covering elements 14 are configured such that a distance between the covering elements 14 in the composite structure corresponds to the distance of the reaction vessel 1 in the area of the opening O to be closed, i.e. for example 9 mm. The openings O are therefore particularly easy to close.

In particular, the projection-shaped elements 16 are further configured analogously to the projection-shaped elements 12 arranged between the reaction vessels 1 such that individual or several covering elements 14 can be separated from the remaining composite structure 15. For this purpose, in a manner not shown in further detail, predetermined breaking points can be provided in the projection-shaped elements 16 or between them and the respective covering elements 14.

In a manner not shown in further detail, the covering element 14 can be present individually or as a composite structure 15 of covering elements 14 separate from the reaction vessel arrangement 11.

FIG. 31 shows a side view of a possible ninth example of the reaction vessel 1. In contrast to the first example of the reaction vessel 1 shown in FIGS. 1 through 3, this vessel is configured as a pipette tip with a measuring chamber 3 that is open to the bottom, inside which the substance is kept in place by a vacuum generated by a liquid column of the substance.

The reaction vessel 1 configured as a pipette tip is also intended in particular for arrangement in a device for automated analysis of a substance that is not shown. In particular, the pipette tip is configured, in a manner not shown, with its proximal end in the area of the upper opening O placed in a fluid-tight manner on the shaft, also referred to as a cone, of a pipette, particularly what is referred to as an air displacement-pipette.

On the side opposite the proximal end in an axial direction of the reaction vessel 1, the distal end of a pipette tip is configured with a lower opening O′, through which the substance to be analyzed is taken up and discharged. The distal end is characterized in particular by an extremely small internal diameter of e.g. 0.4 mm to 0.6 mm and a particularly small external diameter of e.g. 0.8 to 1 mm.

The pipette or pipette tip shown enables analysis of the substance in several layer thicknesses directly in the pipette, without requiring prior transfer of the contents into another vessel.

Here, the measuring chamber 3 with the measuring windows F1 through F8, the transition area UB, and the transition elements between the individual measuring windows F1 through F8 can be configured as desired according to the examples of the reaction vessel 1 shown in FIGS. 1 through 27.

In a configuration of the reaction vessel 1 as a pipette tip, it is also possible for the entire reaction vessel 1 or only parts thereof to be made of the transparent material. In particular, the proximal end of the pipette tip is made of a mechanically flexible material, so that fluid-tight connection with the shaft of the pipette is simply and reliably achievable. For example, the mechanically flexible material can be polypropylene or a thermoplastic polymer. In addition, it is also possible for the reaction vessel 1, at least in the area of the lower opening O′, to be made of a further non-transparent plastic or non-plastic material.

### LIST OF REFERENCE NUMBERS

1 Reaction vessel
2 Storage chamber
3 Measuring chamber
4 Projection
5 Projecting element
6 Projecting element
7 Locking element
8 Locking element
9 Locking element
10 Locking element
11 Reaction vessel arrangement
12 Element
13 Connecting element
14 Covering element
15 Composite structure
16 Element
A1 Distance
A2 Distance
A3 Distance
A4 Distance
F1 Measuring window
F2 Measuring window
F3 Measuring window
F4 Measuring window
F5 Measuring window
F6 Measuring window
F7 Measuring window
F8 Measuring window
O Opening
O′ Opening
UB Transition area

1.-14. (canceled)

15. A reaction vessel (1) for analyzing a substance, comprising:
a storage chamber (2) with a circular cross section and
at least one measuring chamber (3),
wherein the storage chamber (2) and the measuring chamber (3) are interconnected in a transition area (UB) and are intended to receive the substance,
wherein the measuring chamber (3) has several pairs of two opposing, plane-parallel measuring windows each (F1, F2; F3, F4; F5, F6; F7, F8) composed of a transparent material successively configured in plane-parallel levels in the axial direction of the reaction vessel (1) and/or transversely to this axial direction,
wherein a distance (A1, A2, A3, A4) between the measuring windows of a pair (F1, F2; F3, F4; F5, F6; F7, F8) is different from a distance (A2, A3, A4, A1) between the measuring windows of the remaining pairs (F3, F4; F5, F6; F7, F8; F1, F2).

16. The reaction vessel (1) according to claim 15,
characterized in that the measuring windows (F1, F2; F3, F4; F5, F6; F7, F8) are configured solely in four levels arranged in a mutually plane-parallel manner.

17. The reaction vessel (1) according to claim 15,
characterized in that
the storage chamber (2) has a circular opening (O) on an upper end,
that is bordered on its edge by a casing surface of the storage chamber (2),
wherein a projection (4) completely surrounding the casing surface on the end side and outer side and running essentially perpendicularly to the casing surface is configured in the area of the opening (O).

18. The reaction vessel (1) according to claim 16,
characterized in that
the storage chamber (2) has a circular opening (O) on an upper end,
that is bordered on its edge by a casing surface of the storage chamber (2),
wherein a projection (4) completely surrounding the casing surface on the end side and outer side and running essentially perpendicularly to the casing surface is configured in the area of the opening (O).

19. The reaction vessel (1) according to claim 15,
characterized in that the radius of the circular cross section of the storage chamber (2) decreases from an upper end to a lower end of the storage chamber.

20. The reaction vessel (1) according to claim 16,
characterized in that the radius of the circular cross section of the storage chamber (2) decreases from an upper end to a lower end of the storage chamber.

21. The reaction vessel (1) according to claim 17,
characterized in that the radius of the circular cross section of the storage chamber (2) decreases from an upper end to a lower end of the storage chamber.

22. The reaction vessel (1) according to claim 18,
characterized in that the radius of the circular cross section of the storage chamber (2) decreases from an upper end to a lower end of the storage chamber.

23. The reaction vessel (1) according to claim 15,
characterized in that wall areas of the measuring chamber (3) between the measuring windows of a pair (F1, F2; F3, F4; F5, F6; F7, F8) show a curved cross section.

24. The reaction vessel (1) according to claim 16,
characterized in that wall areas of the measuring chamber (3) between the measuring windows of a pair (F1, F2; F3, F4; F5, F6; F7, F8) show a curved cross section.

25. The reaction vessel (1) according to claim 15,
characterized in that at least one projecting element (5, 6) running essentially perpendicularly to a circular upper opening (O) of the storage chamber (2) is configured on an outer side of the storage chamber (2).

26. The reaction vessel (1) according to claim 15,
characterized in that on an outer side of a lower end of the measuring chamber (3), at least one projection-shaped locking element (7 through 10) is configured essentially perpendicularly to a bottom element configured on the lower end.

27. The reaction vessel (1) according to claim 15,
characterized in that a volume of the storage chamber (2) is at least 10 times greater than a volume of the measuring chamber (3).

28. The reaction vessel (1) according to claim 15 configured as a cuvette.

29. The reaction vessel (1) according to claim 15 configured as a pipette or a pipette tip.

30. A reaction vessel arrangement (11) for analyzing a substance, comprising several interconnected reaction vessels (1) according to claim 1.

31. The reaction vessel arrangement (11) according to claim 30,
characterized in that the reaction vessels (1) are configured next to one another in a linear or curved arrangement such that the normal directions of the circular openings (O) configured on the upper end of the storage chambers (2) run parallel to one another respectively.

32. The reaction vessel arrangement (11) according to claim 30, characterized in that
a covering element (14) for closing an opening (O) of the reaction vessel (1) is configured on each reaction vessel (1) by means of a mechanically flexible connecting element (13) and/or
a composite structure (15) of several covering elements (14) is configured on one or several of the reaction vessels (1) by means of a mechanically flexible connecting element (13), wherein a distance between the covering elements (14) located in the composite structure (15) corresponds to a distance between the reaction vessels (1) in the area of the opening to be closed (O).

33. The reaction vessel arrangement (11) according to claim 31, characterized in that
a covering element (14) for closing an opening (O) of the reaction vessel (1) is configured on each reaction vessel (1) by means of a mechanically flexible connecting element (13) and/or
a composite structure (15) of several covering elements (14) is configured on one or several of the reaction vessels (1) by means of a mechanically flexible connecting element (13), wherein a distance between the covering elements (14) located in the composite structure (15) corresponds to a distance between the reaction vessels (1) in the area of the opening to be closed (O).

34. A process for analyzing a substance located inside a reaction vessel (1), the reaction vessel comprising:
a storage chamber (2) with a circular cross section and
at least one measuring chamber (3),
wherein the storage chamber (2) and the measuring chamber (3) are interconnected in a transition area (UB) and are intended to receive the substance,
wherein the measuring chamber (3) has several pairs of two opposing, plane-parallel measuring windows each (F1, F2; F3, F4; F5, F6; F7, F8) composed of a transparent material successively configured in plane-parallel levels in the axial direction of the reaction vessel (1) and/or transversely to this axial direction,
wherein a distance (A1, A2, A3, A4) between the measuring windows of a pair (F1, F2; F3, F4; F5, F6; F7, F8) is different from a distance (A2, A3, A4, A1) between the measuring windows of the remaining pairs (F3, F4; F5, F6; F7, F8; F1, F2);
wherein the process comprises processing and optically examining the substance inside said reaction vessel (1).
